(19) United States
(12) Patent Application Publication
(10) Pub. No.: US 2018/0032990 A1
(43) Pub. Date: Feb. 1, 2018

(54) ITEM LOCATION DETECTION ON SCALES

(71) Applicant: NCR Corporation, Duluth, GA (US)

(72) Inventor: Christopher John Costello, Suwanee, GA (US)

(21) Appl. No.: 15/222,402

(22) Filed: Jul. 28, 2016

(51) Int. Cl. G06Q 20/20; H04N 5/225; G07G 1/00

(52) U.S. Cl. CPC G06Q 20/208; G07G 1/0072; H04N 5/2251

(57) ABSTRACT

The various embodiments herein each include at least one of systems, methods and software for item location detection on scales, such as on scanner/scales that may be deployed at checkout terminals. One such embodiment is in the form of a method that includes processing data with regard to an item present on a scale of a checkout terminal to locate the item on the scale. The data that is processed is captured in some embodiments upon a steady weight condition greater than zero. This method further includes outputting a message from the terminal when an item is not located within a defined acceptable area of the scale.

### BACKGROUND INFORMATION

Shrinkage is a common and expensive problem at retail outlets, such as grocery stores. Shrinkage often occurs right at the checkout stand where items are moved across a scanner/scale without being scanned. Another type of fraud at the checkout terminal is the placing of an item on only a portion of a scale such that the weight of the item is not fully on the scale. Shrinkage can also occur through item substitution; that is, presenting the item, but entering it as a different item.

Some of these issues, such as item substitution fraud are the subject of fraud detection solutions implemented at checkout stands through image processing. However, for such image processing solutions to work properly, an image needs to be properly captured, such as by one or more imaging devices of or coupled to a scanner that capture images for barcode scanning, among other purposes. If an item is not located in an area where the imaging devices are directed, the fraud detection solutions cannot function and are thereby defeated. Thus, some fraud detection solutions can be bypassed by fraudsters and current fraud detection solutions are not able to detect all forms of known fraud.

### SUMMARY

The various embodiments herein each include at least one of systems, methods and software for item location detection on scales, such as on scanner/scales that may be deployed at checkout terminals.

One such embodiment is in the form of a method that includes processing data with regard to an item present on a scale of a checkout terminal to locate the item on the scale. The data that is processed is captured in some embodiments upon a steady weight condition greater than zero. This method further includes outputting a message from the terminal when an item is not located within a defined acceptable area of the scale.

Another method embodiment includes determining a scale has a steady weight greater than zero and capturing an image of at least a portion a top surface of the scale. This method may then determine whether an item is present on the scale surface within an acceptable area and when the item is not present on the scale surface within the acceptable area, output an error indication, such as on a display of the checkout terminal.

A further embodiment is in the form of a terminal, such as a checkout terminal which may be a self-service checkout terminal or a cashier assisted checkout terminal. The terminal typically includes a scanner/scale, at least one imaging device, at least one output device and a computer controlling operation of the terminal. The computer includes at least one processor and at least one memory device storing instructions executable by the processor to perform data processing activities. The data processing activities may include receiving weight measurements over time from the scanner/scale and determining whether an item is present on the scale surface within an acceptable area as included in an image received from the at least one imaging device. The data processing activities may further include outputting an error indication from the at least one output device when the item is not present on the scale surface within the acceptable area.

### BRIEF DESCRIPTION OF THE DRAWINGS

FIG. 1 is a logical block diagram of a checkout terminal, according to an example embodiment.

FIG. 2 is an illustration of an image of a scale surface of a scanner/scale, according to an example embodiment.

FIG. 3 is a block diagram of a computing device, according to an example embodiment.

FIG. 4 is a block flow diagram of a method, according to an example embodiment.

FIG. 5 is a block flow diagram of a method, according to an example embodiment.

### DETAILED DESCRIPTION

The various embodiments herein each include at least one of systems, methods and software for item location detection on scales, such as on scanner/scales that may be deployed at checkout terminals. The various embodiments herein operate to locate an item on a surface of a scale or scanner/scale of a checkout terminal, which may be a self-service or cashier assisted. Some such embodiments may simply operate to determine whether an item for which the scale or scanner/scale is registering a weight is within an acceptable area. When the item is not within the acceptable area, a potential fraud or error condition is declared and a user is instructed via one or both of a displayed message and an audible message or sound. These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor. ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

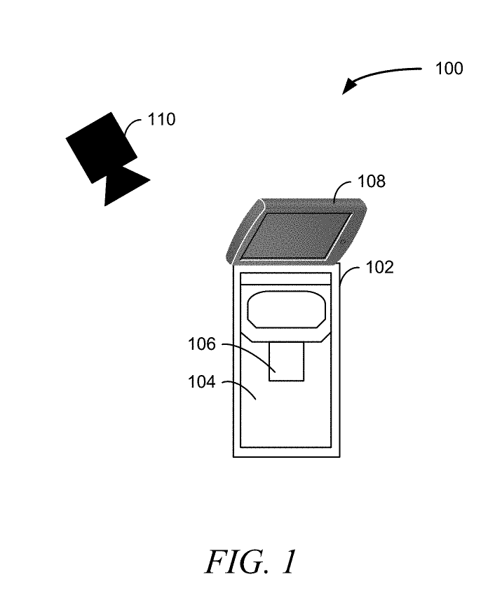

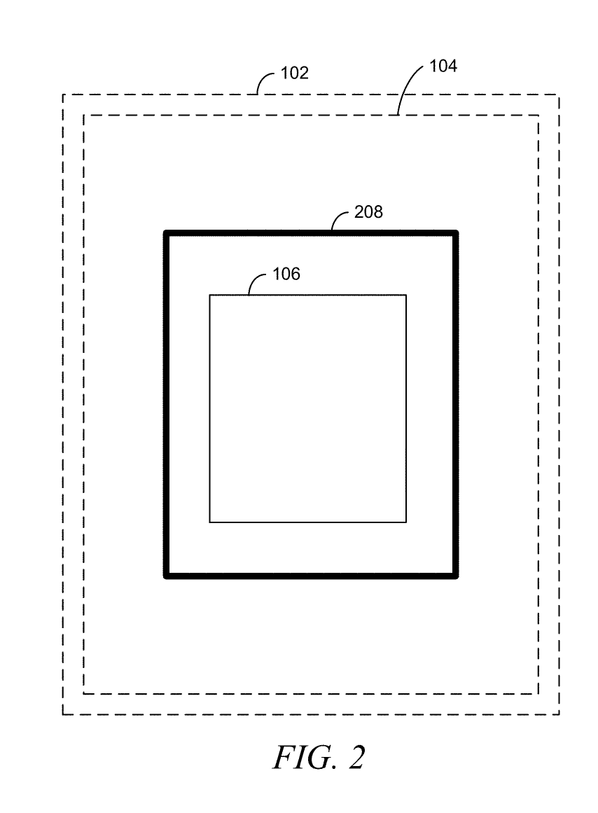

FIG. 1 is a logical block diagram of a checkout terminal 100, according to an example embodiment. The checkout terminal 100, although generally illustrated as a self-service checkout terminal, may instead be a cashier-assisted checkout terminal. The checkout terminal 100 is illustrated in greatly simplified form, but sufficiently to convey the subject matter herein. As illustrated, the checkout terminal 100 includes a scanner/scale 102 and a computing device 108 that controls operation of the checkout terminal. Some embodiments may further include one or more imaging devices 110 that are deployed to capture images of a various views at the checkout terminal, such as a view of a top surface 104 of the scanner/scale 102 or a portion thereof including the scanning window 106. An example of an image that may be captured by the imaging device 110 is illustrated in FIG. 2.

Fraud detection algorithms may be performed on the checkout terminal 100 to detect various types of fraud, such as item substitution fraud and weighing only partial weights of items by placing items to be weighed on only a corner of the scanner/scale 102. However, to ensure such algorithms are able to properly and reliably be applied, various embodiments herein operate to ensure items place on the scale of the scanner/scale 102, or scales of other checkout terminals 100 that include a separate scale, are placed in an acceptable area of the scale. An acceptable area is typically a central area of the scale, such as over a scanning window 106 through which an imaging device of the scanner/scale 102 can capture an image of at least a portion of the item. Similarly, other imaging devices may be utilized, such as an imaging device of the scanner/scale 102 deployed behind a vertical scanning window or the imaging device 110 that may be deployed directly above or an angle above the scanner/scale 102. Images from these other imaging devices may be utilized to identify a location of an item on the scale. In some embodiments, the location of an item on the scale may be a Boolean determination, for example, a determination of whether an item is present or not present within a certain area of the top plate 104 of the scanner/scale 102. Such determinations may be made through image processing, such as subtraction of a reference image from a newly captured image.

In further embodiments, one or more ultrasonic measuring devices may be deployed near a scanning field of the scanner/scale 102 to determine a distance between the respective measuring device and an item that may be present. In such embodiments, the distance may be compared with one or a range of acceptable distances. Further, multiple of such measurements from a two or more measuring devices maybe used to locate an item on the scale in two dimensions. Similarly, edge detection applied against two or more images each captured from a different angle. Such image processing is generally referred to as stereo image processing.

In some other embodiments, the scale, such as the scale of the scanner/scale 102 includes a plurality of weight sensors distrusted under the top plate 104. These sensors measure weight at various locations under the top plate 104 in some embodiments to allow for determination of where an item is placed on the scale. In such embodiments, the locations of these sensors is known and the weights may be utilized to determine whether the item is located within the acceptable area.

Regardless of the method or methods used to determine whether an item is present on the scale surface within an acceptable area, when an item is present on the scale as determined by a stable measured weight of the item greater than zero and that item is not present within an acceptable area, an indication is output from the computing device 108. The indication may be output as an instruction on a display of the computing device 108, as a sound or voice instruction, or both. The instructions generally instruct a user to move the item to the acceptable area.

FIG. 2 is an illustration of an image of a scale surface of a scanner/scale 102, according to an example embodiment. The image may have been captured by the imaging device 110 of FIG. 1 or other imaging device. Although multiple areas of the scale surface are illustrated in the example image, not all areas are included in images captured in all embodiments.

The image of FIG. 2 is of a scale surface of the scanner scale 102. The scale surface includes a top plate 104 upon which items are placed to be weighed. The top plate 104 includes a scanning window 106 therein through which items presented can be scanned for pricing and imaged for various purposes including fraud detection, as well as scanning. An imaging device that captures the image of FIG. 2 may capture an image just as illustrated and the block 208 illustrates the acceptable area within which items are to be placed, in whole or in part, to be weighed. In other embodiments, an imaging device may capture an image only of the area within block 208. Thus, if nothing else is included within an image of block 208, but the scale is registering a steady weight greater than zero, an error condition exists such that the instruction described with regard to FIG. 1 will be output by the checkout terminal 100 of FIG. 1.

Note as well with regard to FIG. 2 that an image may be captured by an imaging device deployed under the scanning window 106. In such embodiments, the acceptable area for processing such images is the area of the scanning window 106.

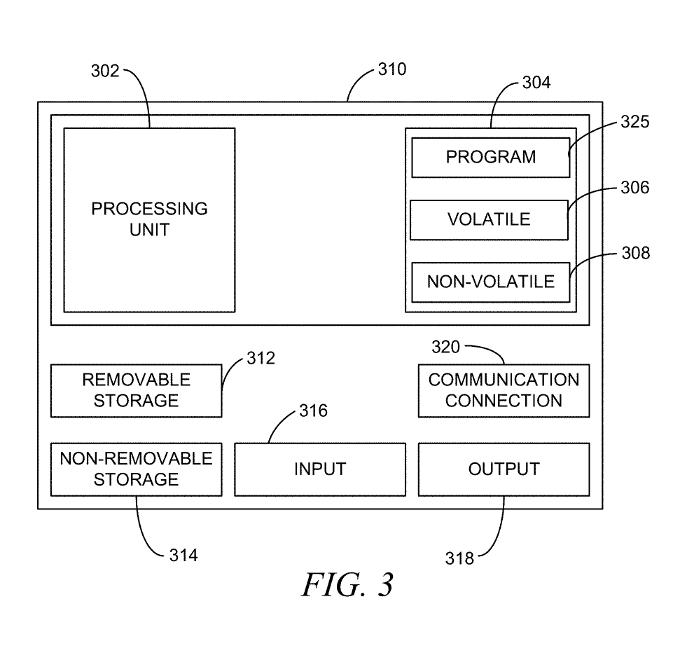

FIG. 3 is a block diagram of a computing device, according to an example embodiment, such as the computing device 108 of FIG. 1 or even the scanner/scale 102 also of FIG. 1. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 310, may include a processing unit 302, memory 304, removable storage 312, and non-removable storage 314. Although the example computing device is illustrated and described as computer 310, the computing device may be in different forms in different embodiments. For example, the computing device may instead be a smartphone, a tablet, smartwatch, or other computing device including the same or similar elements as illustrated and described with regard to FIG. 3. Devices such as smartphones, tablets, and smartwatches are generally collectively referred to as mobile devices. Further, although the various data storage elements are illustrated as part of the computer 310, the storage may also or alternatively include cloud-based storage accessible via a network, such as the Internet.

Returning to the computer 310, memory 304 may include volatile memory 306 and non-volatile memory 308. Computer 310 may include—or have access to a computing environment that includes a variety of computer-readable media, such as volatile memory 306 and non-volatile memory 308, removable storage 312 and non-removable storage 314. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 310 may include or have access to a computing environment that includes input 316, output 318, and a communication connection 320. The input 316 may include one or more of a touchscreen, touchpad, mouse, keyboard, camera, one or more device-specific buttons, one or more sensors integrated within or coupled via wired or wireless data connections to the computer 310, and other input devices. The computer 310 may operate in a networked environment using a communication connection 320 to connect to one or more remote computers, such as database servers, web servers, and other computing device. An example remote computer may include a personal computer (PC), server, router, network PC, a peer device or other common network node, or the like. The communication connection 320 may be a network interface device such as one or both of an Ethernet card and a wireless card or circuit that may be connected to a network. The network may include one or more of a Local Area Network (LAN), a Wide Area Network (WAN), the Internet. and other networks. In some embodiments, the communication connection 320 may also or alternatively include a transceiver device, such as a BLUETOOTH® device that enables the computer 310 to wirelessly receive data from and transmit data to other BLUETOOTH® devices.

Computer-readable instructions stored on a computer-readable medium are executable by the processing unit 302 of the computer 310. A hard drive (magnetic disk or solid state). CD-ROM, and RAM are some examples of articles including a non-transitory computer-readable medium. For example, various computer programs 325 or apps, such as one or more applications and modules implementing one or more of the methods illustrated and described herein or an app or application that executes on a mobile device or is accessible via a web browser, may be stored on a non-transitory computer-readable medium.

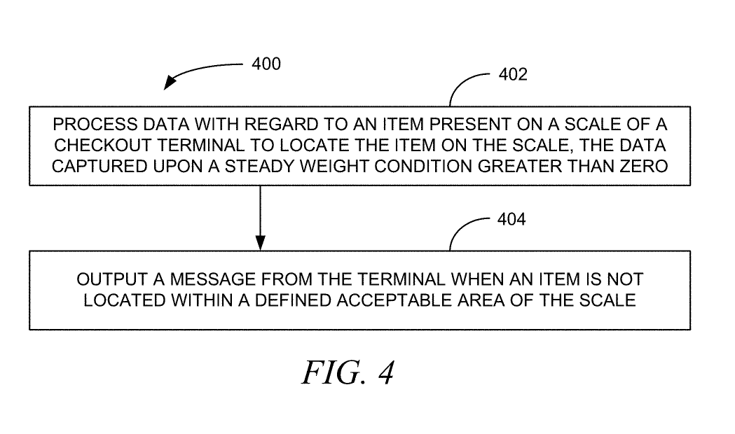

FIG. 4 is a block flow diagram of a method 400, according to an example embodiment. The method 400 may be performed to determine whether items present on a scale are properly located on the scale to allow for proper weighing, fraud detection, and other purposes. The method 400 may be performed on a scale, a computer controlling operation of a checkout terminal, or a combination of both.

The method 400 includes processing 402 data with regard to an item present on a scale of a checkout terminal, such as the terminal 100 of FIG. 1, to locate the item on the scale. The data in such embodiments is typically captured upon a steady weight condition on the scale greater than zero. The method 400 then outputs 404 a message from the terminal when an item is not located within a defined acceptable area of the scale.

In some embodiments, the data processed 402 with regard to the item present on the scale includes data captured by at least one ultrasonic measuring device. The location of the item within the acceptable area of the scale in some such embodiments is determined based on the item being located within an acceptable distance from the at least one ultrasonic measuring device.

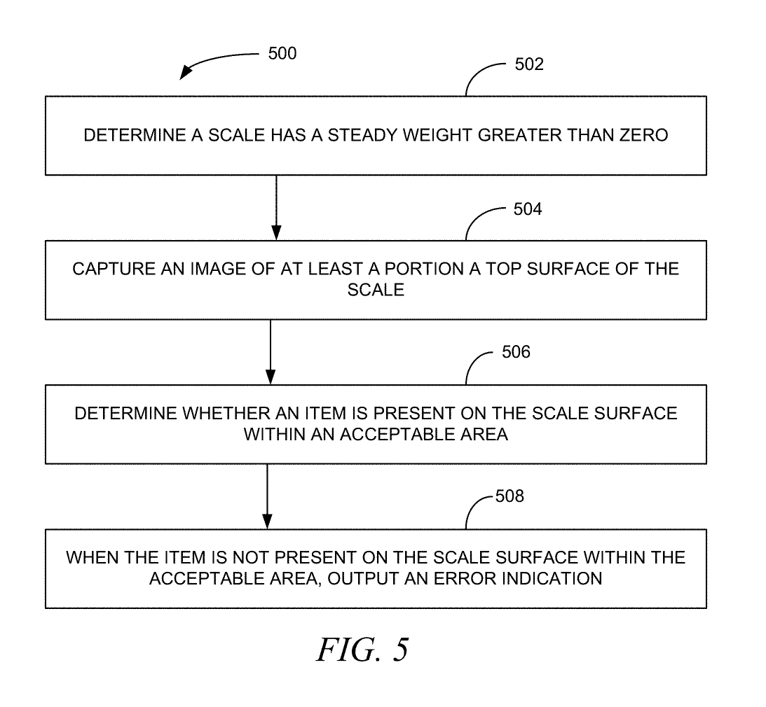

FIG. 5 is a block flow diagram of a method 500, according to an example embodiment. The method 500 may be performed to determine whether items present on a scale are properly located on the scale to allow for proper weighing, fraud detection, and other purposes. The method 500 may be performed on a scale, a computer controlling operation of a checkout terminal, or a combination of both.

The method 500 includes determining 502 a scale has a steady weight greater than zero and capturing 504 an image of at least a portion a top surface of the scale. The method then determines 506 whether an item is present on the scale surface within an acceptable area and, when the item is not present on the scale surface within the acceptable area, outputs 508 an error indication. The error indication may be output as a message from the scale to a terminal instructing the terminal to output a message from the terminal requesting the item on the scale be moved to the acceptable area. In other embodiments, the method 500 is performed in part on terminal and the error condition is identified on the terminal.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
processing data with regard to an item present on a scale of a checkout terminal to locate the item on the scale, the data captured upon a steady weight condition greater than zero; and
outputting a message from the terminal when an item is not located within a defined acceptable area of the scale.

2. The method of claim 1, wherein the data processed with regard to the item present on the scale includes data captured by at least one ultrasonic measuring device and the location of the item within the acceptable area of the scale is determined based on the item being located within an acceptable distance from the at least one ultrasonic measuring device.

3. The method of claim 1, wherein the data processed with regard to the item present on the scale includes a captured image of at least a portion of the scale.

4. The method of claim 3, wherein the image is captured by an imaging device positioned to capture images including at least a center area of the scale.

5. The method of claim 4, wherein the image is captured by a camera positioned under a window in a center of a surface of the scale.

6. The method of claim 3, wherein the processing of the captured image to locate the item present on the scale further includes processing at least one other image, the processing of the images performed to locate where an item is located on the scale within at least the defined acceptable area.

7. The method of claim 1, wherein the message is output via a display device of the terminal instructing a terminal user to move the item present on the scale within the acceptable area.

8. The method of claim 7, wherein the message is output with an audible alert.

9. The method of claim 1, wherein the checkout terminal is a self-service checkout terminal.

10. The method of claim 1, wherein the scale includes a plurality of weight sensors and processing data with regard to an item present on the scale includes processing data from at least some of the plurality of scale weight sensors to locate the item on the scale.

11. A method comprising:
determining a scale has a steady weight greater than zero;
capturing an image of at least a portion a top surface of the scale;
determining whether an item is present on the scale surface within an acceptable area; and
when the item is not present on the scale surface within the acceptable area, outputting an error indication.

12. The method of claim 11, wherein the error indication is output as a message to a terminal instructing the terminal to output a message from the terminal requesting the item on the scale be moved to the acceptable area.

13. The method of claim 11, wherein the scale is a scanner/scale of a checkout terminal.

14. The method of claim 13, wherein the image is captured by an imaging device positioned beneath a scanning window located on scale surface.

15. The method of claim 11, wherein determining whether the item is present on the scale surface within the acceptable area includes processing at least one other image, the determining based on the two images performed to locate where the item is located on the scale surface within at least the defined acceptable area.

16. A terminal comprising:
a scanner/scale;
at least one imaging device;
at least one output device;
a computer controlling operation of the terminal, the computer including at least one processor and at least one memory device storing instructions executable by the processor to perform data processing activities, the data processing activities comprising:
receiving weight measurements over time from the scanner/scale,
determining whether an item is present on the scale surface within an acceptable area as included in an image received from the at least one imaging device; and
outputting an error indication from the at least one output device when the item is not present on the scale surface within the acceptable area.

17. The terminal of claim 16, wherein the at least one imaging device is a component of the scanner/scale.

18. The terminal of claim 16, wherein the at least one output device includes a display device and outputting the error indication includes presenting an instruction to move the item present on the scale within the acceptable area.

19. The terminal of claim 16, wherein the terminal is a self-service checkout terminal.

20. The terminal of claim 16, wherein determining whether the item is present on the scale surface within the acceptable area includes processing at least one other image, the determining based on the two images performed to locate where the item is located on the scale surface within at least the defined acceptable area.
